(19) United States
(12) Patent Application Publication
(10) Pub. No.: US 2019/0106922 A1
(43) Pub. Date: Apr. 11, 2019

(54) WEATHER WINDOW STOP DEVICE AND METHOD

(71) Applicant: William Roy Woodall, Waldorf, MD (US)

(72) Inventor: William Roy Woodall, Waldorf, MD (US)

(21) Appl. No.: 16/134,120

(22) Filed: Sep. 18, 2018

Related U.S. Application Data
(60) Provisional application No. 62/570,475, filed on Oct. 10, 2017.

(51) Int. Cl. E05F 5/00; E05C 19/18

(52) U.S. Cl. CPC E05F 5/003; E05Y 2900/55; E05C 19/188

(57) ABSTRACT

A weather window stop device for a vehicle during a window regulator failure. The weather window stop device includes at least one alloy strap including a first end, a second end, a plurality of bends, and a plurality of fasteners, wherein the device is configured to be removably affixable to a vehicle window to provide a securing means in the event of a window regulator failure.

### CROSS-REFERENCE TO RELATED APPLICATION(S)

The present application is related to and claims priority to U.S. Provisional Patent Application No. 62/570,475 filed Oct. 10, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of window glass holders of existing art and more specifically relates to a weather window stop.

### RELATED ART

Many individuals in modern society drive vehicles for transportation between locations. When a window regulator fails or breaks on a vehicle, the window falls down into the ‘open’ position. This can leave the occupants of the vehicle exposed to the elements. In extreme weather conditions, such as snow or rain, this can interfere with the individual's ability to drive. Children and passengers may be subject to severe weather if the window cannot be secured. Currently the only means to close the window is to manually raise the window and either ‘jam’ the window with a screwdriver like tool or use tape to secure it closed. These methods can damage the window ledge or damage the paint on the vehicle. A suitable solution is desired.

U.S. Pat. No. 6,578,248 to Laslo L. Boldizar relates to a vehicle window support tool. The described vehicle window support tool includes a support frame, a pair of suction cups for clamping the apparatus to the window glass, and a pair of slides which fit in the window channel of the door between the glass panel and the exterior or interior door panel. The window support apparatus opposes sudden downward movement of the window glass panel resulting from gravity and is removably installed on the automobile door to prevent inadvertent falling of the glass panel into the door cavity while repair work is performed on the door or the door's interior components.

### SUMMARY OF THE INVENTION

In view of the foregoing disadvantages inherent in the known window glass holder art, the present disclosure provides a novel weather window stop device. The general purpose of the present disclosure, which will be described subsequently in greater detail, is to provide an efficient and effective weather window stop device.

A weather window stop device is disclosed herein. The weather window stop device includes at least one alloy strap including a first end, a second end, a plurality of bends, and a plurality of fasteners; wherein the device is configured to be removably affixable to a vehicle window to provide a securing means in the event of a window regulator failure.

According to another embodiment, a method of use for a weather window stop device is also disclosed herein. The method includes providing a weather window stop device, locating the window to a closed position, affixing fasteners to a weather window stop device, placing the weather window stop device to the window, removing the weather window stop device after a regulator has been repaired and storing the weather window stop device when not in use.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a weather window stop device, constructed and operative according to the teachings of the present disclosure.

FIG. 1 is a back view of the weather window stop device during an ‘in-use’ condition, according to an embodiment of the disclosure.

FIG. 2 is a perspective view of the weather window stop device of FIG. 1, according to an embodiment of the present disclosure.

FIG. 3 is a front view of the weather window stop device of FIG. 1, according to an embodiment of the present disclosure.

FIG. 4 is a side view of the weather window stop device of FIG. 1, according to an embodiment of the present disclosure.

FIG. 5 is a flow diagram illustrating a method of use for the weather window stop device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a window glass holder and more particularly to a weather window stop device as used to improve the use of windows during regulator failures.

Generally, the present invention temporarily secures the window until repair or replacement of the regulator can be completed. This efficient design (WW-I) allows for a 12×1 inch piece of aluminum to be bent in three places and be inserted into the bottom of the window base after the window is in the closed position. The bends in the bottom of the aluminum are designed to rest on the bottom of the window base. The top of the window stop contains VELCRO (hook and loop) strips that can be attached to the window to hold it into place until repairs can be made. For heavier windows (WW-II) allows a modification of the devise to be made in a (T Shape) with more hook and loop added to support heavier windows. The smaller window stop design (WW III), is made to allow the window to be held in place until the larger stops can be secured in the window. This may be necessary when there is only one person in the vehicle. This present device can be made by using metal or plastic. As described above after the regulator fails the weather window stop is inserted in the window after the lowered window glass is manually raised by hand or closed.

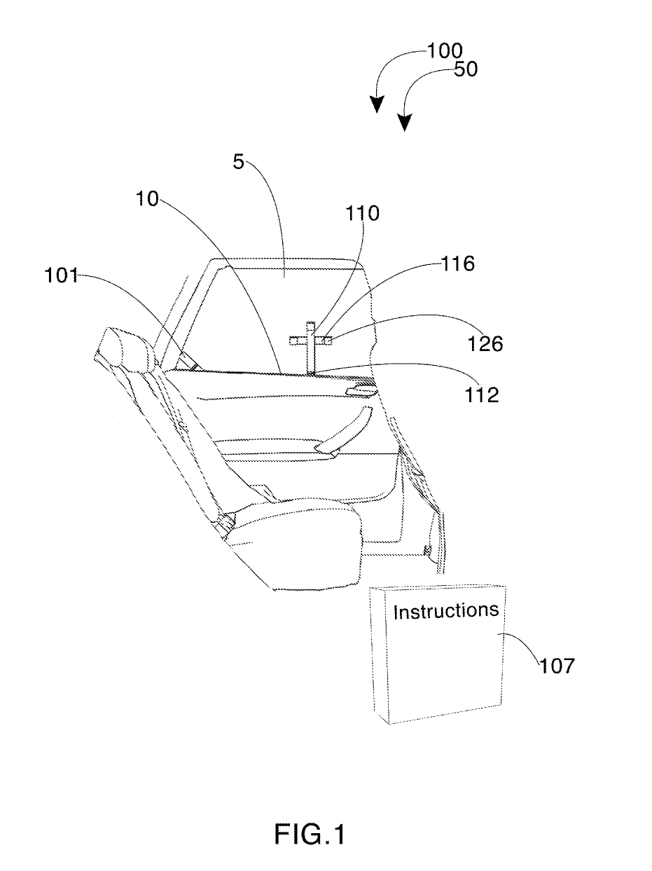

Referring now more specifically to the drawings by numerals of reference, there is shown in FIGS. 1-4, various views of a weather window stop device 100.

FIG. 1 shows a weather window stop device 100 during an ‘in-use’ condition 50, according to an embodiment of the present disclosure. Here, the weather window stop device 100 may be beneficial for use by a user 40 to provide reliable means to protect a driver and passengers from severe weather when a window regulator breaks or fails. The weather window stop device 100 prevents the window 5 from falling, down in the open position and exposing all occupants to snow, rain, or extreme temperatures. The device 100, further enables the driver to stabilize the window 5 until a repair can be performed. It prevents damage to the interior of a vehicle caused by exposure to the elements. The present invention protects the contents of a vehicle against theft when a window 5 is left open. As illustrated, the weather window stop device 100 may comprise: at least one alloy strap 110 including, a first end 120, a second end 130, a plurality of bends and a plurality of fasteners 140.

The weather window stop device 100 may be configured to be removably affixable to a vehicle window 5 to provide a securing means in an event of a window regulator failure. The plurality of bends preferably includes a first ninety-degree bend 142, a one hundred eighty-degree bend 144 and a second ninety-degree bend 146. The bends may be configured to provide an extruded support 112 extending at a right angle from a back side 114 of the at least one alloy strap 110. The extruded support 112 may be configured to rest on a lower window seal 10 when in use. A secondary cross support 116 may be fixed proximate to the first end 120 approximately one to two inches from the first end 120.

The secondary cross support 116 includes a right end 122 and a left end 124 and the at least one alloy strap 110 may be approximately twelve inches in length having a width of approximately one inch. The plurality of bends may be approximately two inches from the second end 130. Further the plurality of fasteners 140, may be hook and loop adhesively affixed to the window 5 and the weather window stop device 100 in a functional orientation to normal-window-vertical-profile. The right end 122 and the left end 124 of the secondary cross support 116 each may also include plastic tips 126. The plastic tips 126 may be useful to resist relative movement of the window 5, furthermore the relative movement of the window 5 is minimized from friction between the plastic tips 126 and the window 5.

According to an embodiment of the present disclosure the plurality of fasteners 140, may be suction cups affixed to the at least one alloy strap 110. Still in other embodiments the device 100 may be constructed using composite material. In such embodiments the device includes an extrude support 112 approximately two inches from the second end 130.

Additionally, a mini version 101 may also be envisioned useful to provide additional stability of the window 5 wherein the device comprises an alloy strap 110 approximately six inches in length including the plurality of bends at the mid-section. It should also be noted that an embodiment may include a plurality of bends each comprising V-shape-bends. Upon reading this specification, it should be appreciated that, under appropriate circumstances, considering such issues as user preferences, design preference, structural requirements, marketing preferences, cost, available materials, technological advances, etc., other device arrangements such as, for example, differing length, width, fasteners, extruded support placements/configurations, etc., may be sufficient.

According to one embodiment, the weather window stop device 100 may be arranged as a kit 105. In particular, the weather window stop device 100 may further include a set of instructions 107. The instructions 107 may detail functional relationships in relation to the structure of the weather window stop device 100 such that the weather window stop device 100 can be used, maintained, or the like, in a preferred manner.

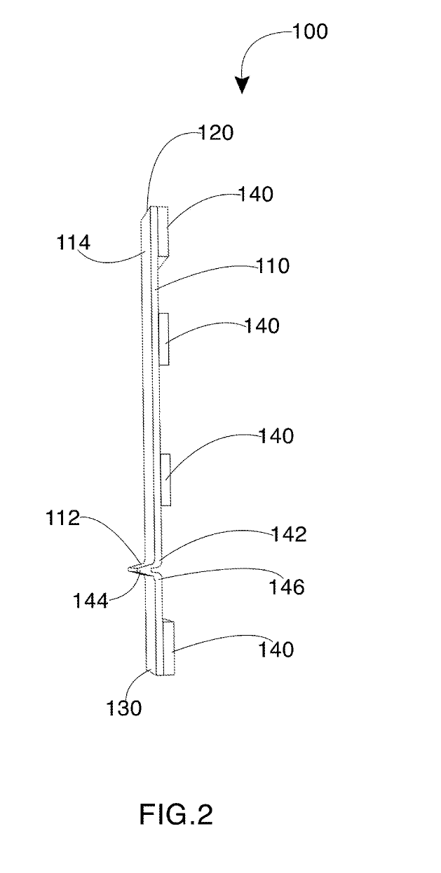

Referring now to FIG. 2 showing the weather window stop device 100 of FIG. 1, according to an embodiment of the present disclosure. As above, the weather window stop device 100 may include at least one alloy strap 110. The at least one alloy strap 110 may include a first end 120, a second end 130, a plurality of bends and a plurality of fasteners 140; wherein the device is configured to be removably affixable to a vehicle window 5 as shown in FIG. 1, to provide a securing means in the event of a window regulator failure.

The at least one alloy strap 110 may be approximately twelve inches in length having a width of approximately one inch. The device includes an extrude support 112 approximately two to three inches from the second end 120. The extruded support 112 may include a plurality of bends. The bends may include a first ninety-degree bend 142, a one hundred eighty-degree bend 144 and a second ninety-degree bend 146 configured to provide an extruded support 112 extending at a right angle from a back side 114 of the at least one alloy strap 110. The extruded support 112 is configured to rest on a lower window seal 10 shown in FIG. 1.

As shown in FIG. 2 the device 100 may further include a plurality of fasteners 140. According to an embodiment of the present disclosure the plurality of fasteners 140, may be hook and loop adhesively affixed to the window 5 and the weather window stop device 100 in a functional orientation to normal-window-vertical-profile as shown in FIG. 1.

As above, embodiments may be envisioned using a composite or rubber material and may be formed using an injection molding process or other means of forming a composite and rubber materials. Additionally, the plurality of fasteners may include for example suction cups, putty, tape or other non-permanent adhesives. It should be noted that in other embodiments the plurality of bends may be configured comprising V-shape-bends or bends that may be suitable to meet the contours needed to match the support area of the lower window seal 10.

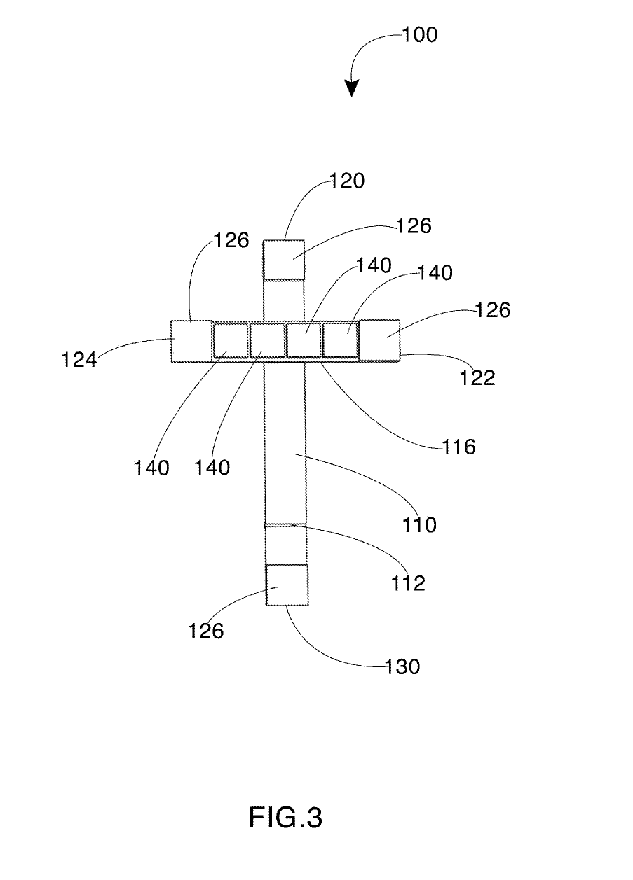

FIG. 3 is a front view of the weather window stop device 100 of FIG. 1, according to an embodiment of the present disclosure. As above weather window stop device 100 comprise: at least one alloy strap 110 including, a first end 120, a second end 130, a plurality of bends and a plurality of fasteners 140. A secondary cross support 116 may be fixed proximate to the first end 120 approximately one to two inches from the first end 120. The secondary cross support 116 includes a right end 122 and a left end 124.

The cross support 116 may be an additional alloy strap attached integral to the at least one alloy strap 110 via rivets, welding or epoxy. The secondary cross support also includes plastic tips 126, the plastic tips 126 resist relative movement of the window 5. The relative movement of the window 5 may be minimized from friction between the plastic tips 126 and the window 5.

As shown in FIG. 3 the at least one alloy strap also preferably includes plastic tips 126 on the first end 120 and the second end 130. The plurality of bends shown more clearly in FIG. 2 includes a first ninety-degree bend 142, a one hundred eighty-degree bend 144 and a second ninety-degree bend 146 configured to provide an extruded support 112 extending at a right angle from a back side of the at least one alloy strap. FIG. 3 shows the plurality of fasteners 140 affixed to the secondary cross support 116, although the fasteners may be affixed at any desired point on the device 100.

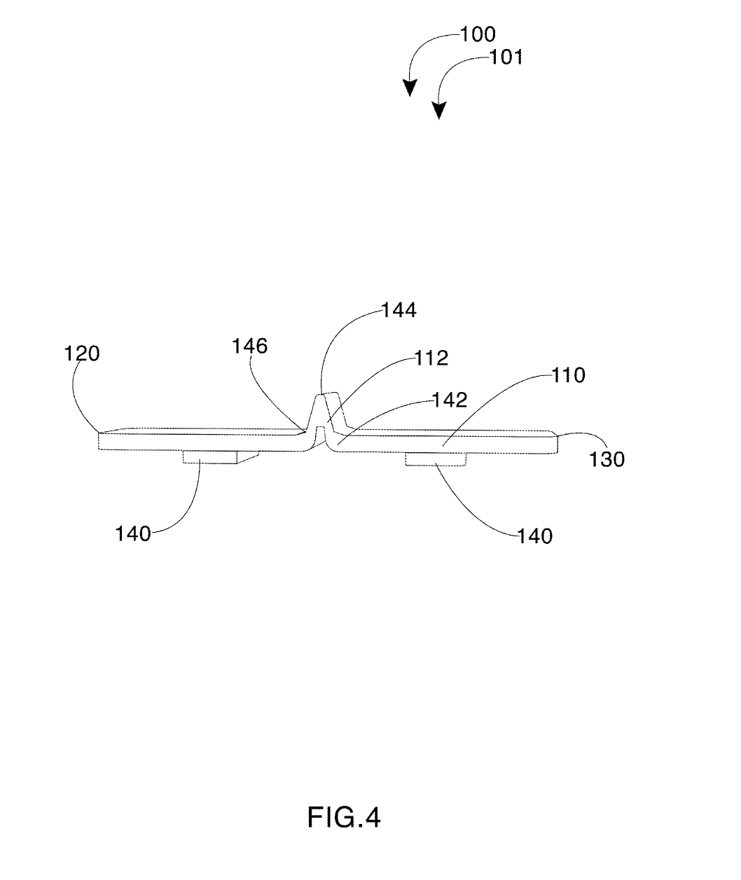

FIG. 4 is a side view of the weather window stop device 100 of FIG. 1, according to an embodiment of the present disclosure. A mini version 101 may also be envisioned useful to provide additional stability of the window 5 as shown in FIG. 1 in use. The mini version 101 comprises an alloy strap 110 approximately six inches in length having a first end 120 and a second end 130 including the plurality of bends at the mid-section. As shown in FIG. 4 the plurality of bends may also include first ninety-degree bend 142, a one hundred eighty-degree bend 144 and a second ninety-degree bend 146 are configured to provide an extruded support 112 extending at a right angle from a back side of the at least one alloy strap 110. Other angles may be used.

According to an embodiment as above in FIG. 1 the mini version 101 also includes an extruded support 112 configured to rest on a lower window 5 seal and a plurality of fasteners 140. The plurality of fasteners 140, may be hook and loop adhesively affixed to the window 5 and the weather window stop device in a functional orientation to normal-window-vertical-profile. Other fastening means may be used. The mini version 101 of the device may be configured to have a plurality of bends each comprising V-shape-bends. Further the plurality of fasteners 140 may be affixed at any desired location and not limited to more than one.

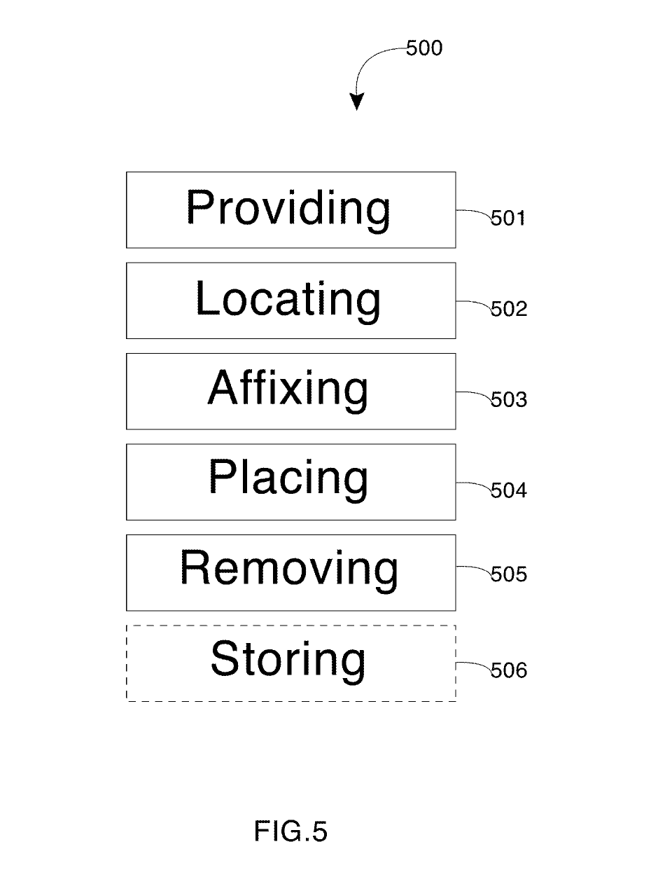

FIG. 5 is a flow diagram illustrating a method for use 500 of the weather window stop device 100, according to an embodiment of the present disclosure. In particular, the method 500 for weather window stop device 100 may include one or more components or features of the weather window stop device 100 as described above. As illustrated, the method for using 500 weather window stop device 100 may include the steps of: step one 501, providing a weather window stop device for a vehicle during a window regulator failure, the device comprising: at least one alloy strap including; a first end; a second end; a plurality of bends; and a plurality of fasteners; wherein the device is configured to be removably affixable to a vehicle window to provide a securing means in the event of a window regulator failure; step two 502, (manually) locating the window to a closed position; step three 503, affixing fasteners to a weather window stop device; step four 504, placing the weather window stop device to the window such that the extrude support is to rest on a lower window seal; step five 505, removing the weather window stop device after a regulator has been repaired; and step six 506, storing the weather window stop device when not in use. Those with ordinary skill in the art will now appreciate that upon reading this specification and by their understanding the art of window glass holders as described herein, methods of using the mini version 101 as described in FIGS. 1 & 4 will be understood by those knowledgeable in such art.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for weather window stop device are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A weather window stop device for a vehicle during a window regulator failure, the device comprising:
at least one alloy strap including;
a first end;
a second end;
a plurality of bends; and
a plurality of fasteners; and
wherein the device is configured to be removably affixable to a vehicle window to provide a securing means in the event of said window regulator failure.

2. The device of claim 1, wherein the plurality of bends includes a first ninety-degree bend, a one hundred eighty-degree bend and a second ninety-degree bend configured to provide an extruded support extending at a right angle from a back side of the at least one alloy strap.

3. The device of claim 2, wherein the extruded support is configured to rest on a lower window seal.

4. The device of claim 1, further comprises a secondary cross support fixed proximate to the first end approximately one to two inches from the first end;
wherein the secondary cross support includes a right end and a left end.

5. The device of claim 1, wherein the alloy strap is approximately twelve inches in length having a width of approximately one inch.

6. The device of claim 1, wherein the plurality of bends are approximately two inches from the second end.

7. The device of claim 1, wherein the plurality of fasteners, are hook and loop adhesively affixed to the window and the weather window stop device in a functional orientation to normal-window-vertical-profile.

8. The device of claim 1, wherein the plurality of fasteners, are suction cups affixed to the alloy strap.

9. The device of claim 1, wherein the device is constructed using composite material.

10. The device of claim 9, wherein the device includes an extrude support approximately two inches from the second end.

11. The device of claim 1, wherein the at least one alloy strap comprises an alloy strap approximately six inches in length including the plurality of bends at the mid-section.

12. The device of claim 1, wherein the plurality of bends each comprise at least one U-shape-bend.

13. The device of claim 1, wherein the plurality of bends each comprise V-shape-bends.

14. The device of claim 4, wherein the right end and the left end of said secondary cross each comprise plastic tips.

15. The device of claim 14, wherein the plastic tips resist relative movement of said window.

16. The device of claim 1, wherein the relative movement of said window is minimized from friction between said plastic tips and said window.

17. A weather window stop device, the device comprising: at least one alloy strap including;
a first end;
a second end;
a plurality of bends; and
a plurality of fasteners; and
wherein the device is configured to be removably affixable to a vehicle window to provide a securing means in an event of said window regulator failure;
wherein the plurality of bends includes a first ninety-degree bend, a one hundred eighty-degree bend and a second ninety-degree bend configured to provide an extruded support extending at a right angle from a back side of at least one alloy strap;
wherein the extruded support is configured to rest on a lower window seal;
wherein a secondary cross support is fixed proximate to a first end one inch from the first end;
wherein the secondary cross support includes a right end and a left end;
wherein the alloy strap is approximately twelve inches in length having a width of approximately one inch;
wherein the plurality of bends are approximately two inches from the second end;
wherein the plurality of fasteners, are hook and loop adhesively affixed to glass and support in a functional orientation to a normal-glass-vertical-profile;
wherein the plurality of bends comprises at least one U-shape-bend;
wherein the right end and the left end of said secondary cross support each comprise plastic tips;
wherein the plastic tips resist relative movement of said window and;
wherein the relative movement of said window is minimized from friction between said plastic tips and said window.

18. The device of claim 17, further comprising set of instructions; and
wherein the device is arranged as a kit.

19. A method of using a weather window stop device, the method comprising the steps of:
providing a weather window stop device for a vehicle during a window regulator failure, the device comprising:
at least one alloy strap including;
a first end;
a second end;
a plurality of bends; and
a plurality of fasteners;
wherein the device is configured to be removably affixable to a vehicle window to provide a securing means in the event of said window regulator failure;
locating the window to a closed position;
affixing fasteners to a weather window stop device; and
placing the weather window stop device to the window.

20. The method of claim 19, further comprising the steps of
removing the weather window stop device after a regulator has been repaired; and
storing the weather window stop device when not in use.
